(19) United States
(12) Patent Application Publication
(10) Pub. No.: US 2007/0290881 A1
(43) Pub. Date: Dec. 20, 2007

(54) Wireless remote control, system and method

(75) Inventors: Pavel Nikitin, Seattle, WA (US); Venkata Kodukula, Bothell, WA (US); Rene Martinez, Seattle, WA (US)

Correspondence Address: SEED INTELLECTUAL PROPERTY LAW GROUP PLLC, 701 FIFTH AVENUE, SUITE 5400, SEATTLE, WA, 98104-7092, US

(73) Assignee: Intermec IP Corp., Woodland Hills, CA (US)

(21) Appl. No.: 11/452,596

(22) Filed: Jun. 13, 2006

(51) Int. Cl. G08C 19/00

(52) U.S. Cl. 340/825.69; 340/825.72; 340/10.1; 341/176; 340/10.34

(57) ABSTRACT

Wireless remote control may omit batteries. A carrier wave from an external carrier wave source may be modulated and backscattered with information identifying a user selection. The backscattered modulated carrier wave response may be received and interpreted for controlling one or more electronic devices.

### BACKGROUND

1. Field

This disclosure generally relates to remote controls and to and methods employing remote controls.

2. Description of the Related Art

Remote controls are ubiquitous in modern day life. Remote controls allow users to control various functions of systems or devices without having to approach or be proximate the remotely controlled system or device.

For example, many households have one or more remote controls that allow a user to control a television, audio equipment, and/or associated peripherals. Such remote controls may, for example, allow a user to turn ON and OFF a television, video cassette recorder (VCR), digital video disk (DVD) player, set-top box, audio amplifier, surround sound system, radio tuner, and/or compact disk (CD) player. The remote control may allow the user to adjust a volume level of a TV, stereo, surround sound system, or other audio and/or video equipment. The remote control may allow a user to select a channel on a television or radio tuner. Remote control for televisions, audio equipment and associated peripheral equipment are typically configured to be hand-held. These remote controls typically transmit a code in pulses of infrared light produced by one or more light emitting diodes (LEDs). Consequently, these remote controls have a limited in range, and are typically limited to use to line-of-sight applications. Such remote controls have become increasingly complex, often including thirty-five or more user selectable keys.

Also for example, many households have one or more remote controls to control a garage door. Such remote controls may be hand-held, or may be integrated into a vehicle. These remote controls may include a single activation button for toggling between open and closed positions of the garage door. More sophisticated versions may provide additional functionality. A further example of a common remote control is a key fob associated with automobiles. Such key fobs typically allow a user to lock and unlock the doors and/or trunk or hatchback of a vehicle from a distance. Such key fobs may also allow the user to turn ON and OFF an alarm system and/or the engine of vehicle, and may provide additional features such as a panic feature for causing the alarm system to sound. There are numerous other examples of remote controls, which are not described here for the sake of brevity. Such remote controls typically transmit a radio frequency (RF) signal, and consequently consume substantially more power than remote controls that emit infrared light for communications.

Remote controls require power to operate. Power is typically supplied by batteries housed in a housing of the remote control. Batteries however impose a number of limitations on the remote control. For example, batteries store a limited amount of charge, and need frequent replacement and/or recharged. The need for replacement or recharging may be highly inconvenient, for example where the remote control is useful in gaining access to replacement batteries or recharging unit Batteries may also limit the reliability of a remote control, failing to make good electrical contact or when partially discharged. Further, batteries may impose severe weight and form factor constraints on remote controls. Even further, batteries may render the remote control susceptible to water and/or adverse weather conditions including low temperature conditions. While remote controls may be made water resistant or waterproof, such adds to the complexity and cost of the remote control. Additionally, the use of batteries may increase the cost of the remote control.

A remote control, a system employing a remote control, and a method of operating the same that address one or more of the above limitations or constraints associated with batteries, would be highly desirable.

### BRIEF SUMMARY

In one embodiment, a wireless remote control operable to control at least one remote device comprises at least a first antenna configured to receive carrier waves from a carrier wave source that is separate and distinct from the wireless remote control, at least a first passive power supply circuit configured to modulate at least some of the carrier waves received via the first antenna with information, and to cause the wireless remote control to backscatter the modulated carrier waves, and at least the first user actuatable switch operable to selectively cause the first passive power supply circuit to modulate the received carrier wave with a first piece of information.

In another embodiment, a wireless, batteryless, remote control operable to control at least one remote device comprises at least a first antenna configured to receive carrier waves from a carrier wave source, the carrier wave source being separate and distinct from the wireless, batteryless, remote control, at least a first user actuatable switch, and at least a first passive power supply circuit operatively coupleable to at least the first antenna by at least the first user actuatable switch, and configured to modulate at least some of the carrier waves received via the first antenna with a first piece of information, and to cause the wireless, batteryless, remote control to backscatter the modulated carrier waves, wherein the first user actuatable switch is operable to selectively electrically couple at least the first antenna to the first passive power supply circuit and electrically uncouple at least the first antenna from the first passive power supply circuit.

In yet another embodiment, a method of operating a wireless, batteryless, remote control comprises receiving a carrier wave at a first antenna, receiving a user selection via at least a first user actuatable switch, modulating the carrier wave based on the received user selection, and backscattering the modulated carrier wave from the wireless, batteryless, remote control.

In still another embodiment, a system comprises a carrier wave source, a wireless remote control comprising at least a first antenna configured to receive carrier waves from the carrier wave source, at least a first passive power supply circuit configured to modulate at least some of the carrier waves received via the first antenna with information, and to cause the wireless remote control to backscatter the modulated carrier waves, and at least the first user actuatable switch operable to selectively cause the first passive power supply circuit to modulate the received carrier wave with a first piece of information, and at least one electronic device remotely operable via the remote control, at least one electronic device comprising a second antenna configured to receive the modulated carrier waves from the wireless remote control, the remote device responsive to the information modulated in the modulated carrier wavers backscattered by the remote control.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram showing a system including a wireless remote control receiving a carrier wave from a carrier wave source and providing a modulated carrier wave to control an electronic device remotely located from the remote control, according to one illustrated embodiment.

FIG. 2 shows a top plan view of the circuitry and the antenna of the remote control of FIG. 1, according to one illustrated embodiment.

FIG. 3 is a flow diagram showing a method of operating the system of FIG. 1, according to one illustrated embodiment.

FIG. 4 is a schematic diagram of a remote control having a plurality of distinct antennas, according to another illustrated embodiment.

FIG. 5 is a schematic diagram of a remote control employing a single passive power supply circuit with a plurality of switches, according to one illustrated embodiment.

FIG. 6 is a schematic diagram of a remote control similar to that of FIG. 5 and further including a security module that is selectively removable with respect to the wireless remote control, according to one illustrated embodiment.

FIG. 7 is a schematic diagram showing a remote control that permits the functionality of a user actuatable switch to be reprogrammed, according to one illustrated embodiment.

FIG. 8 is a schematic diagram showing a remote control including the security module of FIG. 6, the reprogrammability of FIG. 7, as well as a memory module that is selectively removable from the wireless remote control, according to another illustrated embodiment.

FIG. 9 is a graph showing read range performance of an exemplary remote control, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with radio frequency identification (RFID) including antennas, passive power supply circuits, front-ends, memories, packaging and/or readers or interrogators have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings and Abstract of the Disclosure provided herein are for convenience only and do not interpret the scope or meaning of the embodiments.

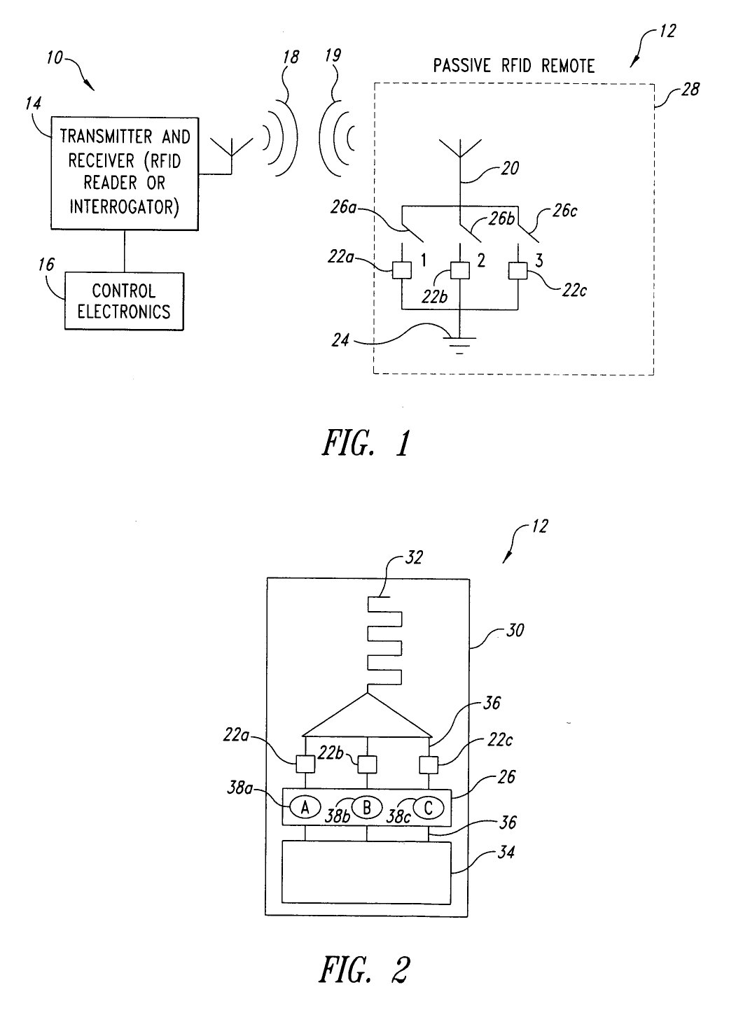

FIG. 1 shows a system 10 including a wireless remote control 12, a carrier wave source 14, and an electronic device 16, where the remote control 12 may be located remotely from the electronic device 16, according to one illustrated embodiment. The carrier source 14 is operable to transmit carrier waves 18 which the remote control 12 returns as carrier wave responses 19, according to one illustrated embodiment. In at least some embodiments, the remote control 12 modulates and backscatters the carrier wave 18 received from the carrier source 14 as the carrier wave response 19.

The carrier source 14 may take the form of an RFID reader or interrogator. RFID readers or interrogators are commercially available in the automatic data collection field (ADC), and are typically employed for reading and/or writing to RFID tags or labels. In some embodiments, the carrier source 14 may be discrete or otherwise distinct from the electronic device 14, while in other embodiments the carrier source 14 may be integrated into a housing or circuitry of the electronic device 16.

The wireless remote control 12 includes one or more antennas 20, one or more passive power supply circuits 22a-22c (three illustrated in FIG. 1, collectively referenced as 22), a ground 24, and one or more user actuatable switches 26a-26c (three illustrated in FIG. 1, collectively referenced as 26). The user actuatable switches 26a-26c are operable to selectively electrically couple respective ones of the passive power supply circuits 22a-22c to the antenna 20, to complete an RFID circuit between the ground 24 and antenna 20.

The antenna 20 may be shaped and otherwise configured to receive and/or transmit at or within a frequency range emitted by the carrier wave source 18. For example, the antenna may have a serpentine shape, crenulated shape, coil or volute shape, or a dipole T-shape or dipole opposing L-shape. The antenna 20 may include more than one antenna element, for example one or more passive antenna elements. Numerous suitable antenna shapes and structures are known in the RFID art.

As used herein and in the claims, the term passive power supply circuit and variations of such means a circuit that derives power via incident electromagnetic energy, such as energy the radio frequency or microwave portions of the electromagnetic spectrum. The passive power supply circuits 22 may take the form of one or more RFID integrated circuits or chips. RFID integrated circuits or chips are commercially available, for example from Intermec, Avery-Dennison, Hewlett-Packard, and Texas Instruments to name a few. The passive power supply circuits 22 may supply sufficient power to operate the remote control 12 without the use of active power supply sources or storage devices (e.g., battery cells, fuel cells, and/or ultracapacitors). Some embodiments, may employ one or more active power supply sources in addition to the passive power supply circuits 22.

Each of the passive power supply circuits 22a-22c may be operable to modulate the received carrier wave 18 with information, and to backscatter the carrier wave response 19 via the antenna 20. For example, each of the passive power supply circuits 22a-22c may be operable to modulate the received carrier wave 18 with an identifier, which may or may not be unique over a large number of passive power supply circuits (e.g., over thousands, millions or billions). In some embodiment, each of the passive power supply circuits 22a-22c is operable to modulate the received carrier wave 18 with an identifier that is unique within a set of having a size equal to, or greater than, the total number of user actuatable switches carried by the remote control 12. In another embodiment, the passive power supply circuits 22a-22c are operable to modulate the received carrier wave 18 with an identifier that is unique within a set having a much larger size than the total number of user actuatable switches carried by the remote control 12. Such embodiments may allow the carrier wave source 14 and/or electronic device 16 to learn or associate the unique identifiers of an associated remote control 12, thereby reducing or eliminating interference from other remote controls 12 not associated with the particular carrier wave source 14 or electronic equipment 16.

The user actuatable switches 26 may take a variety of forms, for example, mechanical contact switches and/or inductive switches. The user actuatable switches 26 may take the form of membrane switches, touch-sensitive or tactile switches, toggle switches, rocker switches, push-button switches, rotary switches, and/or snap switches, to name a few. Those of ordinary skill in the art can select appropriate switches for the specific application, from the above choices or from the numerous other well known and/or commercially available switches.

The wireless remote control 12 may include a housing 28. The housing 28 may be sized and dimensioned to be grasped or held in a user's hand. Such housings 28 may, for example, be similar or identical to the housings of existing remote controls typically associated with televisions, audio equipment and peripherals. In some embodiments, the housing 28 of the remote control 12 may be substantially smaller than those of existing remote controls since the remote control 12 may advantageously operate without batteries and/or may omit light sources such as LEDs. The housing 28 may, for example, be sized and dimensioned to be carried on a key chain as a fob.

Alternatively, the remote control 12 may be integrated into larger housings, devices and/or systems. For example, the remote control 12 may be integrated into a door of a vehicle, for example an automobile, to function as a keyless entry system. In such an embodiment, the door of the vehicle may form the housing 28, or a portion of a door may form the housing 28. Additionally, or alternatively, the remote control 12 may include a housing 28 distinct from the door or portion of the door. Alternatively, the remote control 12 may be positioned elsewhere on the vehicle, or example on a window post or pillar. Also for example, the remote control 12 may be located in or proximate a door or doorframe of a house or garage. Again, the door or doorframe may form the housing 28, and/or the remote control 12 may include a housing 28 distinct from the door or door frame. As an even further example, the remote control 12 may be integrated into a keyboard structure, such as those commonly associated with computers. Such may eliminate the need for wired connections between the keyboard and the corresponding port (e.g., USB port) of the computing system. In such embodiments, the frame of the keyboard forms the housing 28. Numerous other examples and applications are of course possible, but are not be described further in the interest of clarity and brevity.

The electronic device 16 may take any of a variety of forms. For example, the electronic device 16 may take the form of a television, VCR, DVD player, set-top box, audio amplifier, surround sound system, radio tuner, and/or compact disc (CD) player. The electronic device may, for example, take the form of an automatic garage door opener. The electronic device may, for example, take the form of a latch or lock system, for example for a garage, residence, and/or vehicle. The electronic device may, for example, take the form of an alarm system for a residence or vehicle. The electronic device may, for example, take the form of an ignition cutoff system for a vehicle. The electronic device may, for example, take the form of a keyboard to operate a computer, phone, or other device. The examples of various forms that electronic device 16 can take are too numerous to setout herein without distracting from the teachings. Those of ordinary skill in the art will easily recognize other forms of electronic devices that may be remotely controlled via the remote control 12 based on the present teachings.

FIG. 2 shows the circuitry of wireless remote control 12 according to one illustrated embodiment.

The wireless remote control 12 may include a dielectric substrate 30 with an antenna trace 32, an antenna ground trace 34, and other electrically conductive paths or traces 36. The electrically conductive traces 32, 34, 36 may be formed by printing or otherwise depositing electrically conductive material on the dielectric substrate 30. Additionally or alternatively, the electrically conductive traces 32, 34, 36 may be formed by masking and/or etching. Depositing, masking and/or etching may employ techniques common in the production of printed circuit boards and/or integrated circuit fabrication. Consequently, such techniques are not discussed in detail.

The passive power supply circuits 22 may be electrically coupled to the traces 36 using flip-chip techniques or other standard techniques for mounting integrated circuits to substrates. The user actuatable switches 26 may be individually mounted to the dielectric substrate 30, or may be packaged and mounted as one or more groups of switches. The user actuatable switches 26 may have one or more user actuatable elements, for example keys or buttons 38a, 38b, 38c (three illustrated in FIG. 2, collectively referenced as 38) which are accessible or otherwise actuatable by the user.

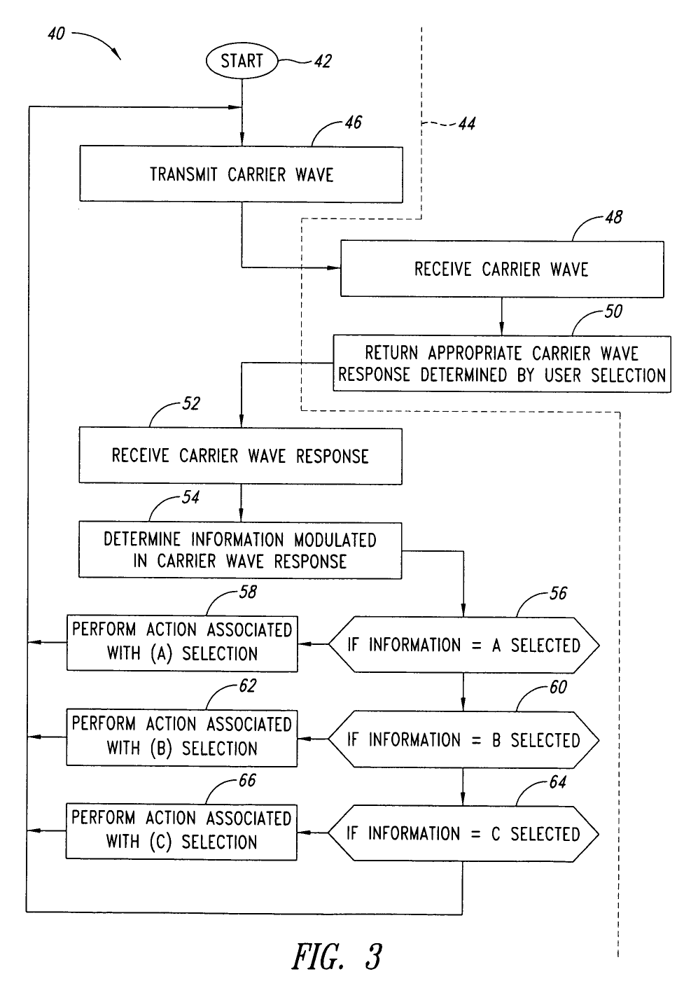

FIG. 3 shows a method 40 of operating the system of FIG. 1, according to one illustrated embodiment, starting at 42. To facilitate understanding of the method 40, acts and other operations performed by or at the carrier wave source 14 or electronic device 16 are illustrated to the left of broken line 44 in FIG. 3, while acts and other operations performed by the remote control 12 are illustrated to the right of the broken line 44.

At 46, the carrier source 14 transmits a carrier wave 18. The carrier source 14 may, for example, transmit a carrier wave 18 in the form of a constant wavelength signal, and may, for example, operate in the UHF ISM band (e.g., 902-928 MHz). In other embodiments, the carrier source 14 may, for example, transmit a carrier wave 18 which is modulated with an identifier that indicates a specific one or the passive power supply circuits 22 which is being interrogated or queried.

At 48, the wireless remote 12 receives the carrier wave 18. At 50, the wireless remote 12 returns a carrier wave response 19. If the user has actuated one or more of the user actuatable switches 22, the wireless remote returns a carrier wave response that is modulated with appropriate information identifying the actuated switch 22. The wireless remote 12 may advantageously backscatter the received carrier wave 18 as the carrier wave response 19. In such embodiments, the wireless remote 12 may operate at range of, for example, approximately 50 feet.

At 52, the carrier wave source 14 receives the carrier wave response 19. At 54, the carrier wave source 14 or the electronic device 16 determines the information encoded in the carrier wave response 19, if any. For example, the carrier wave source 14 or the electronic device 16 determines an identifier encoded in the carrier wave response 19.

At 56, the carrier wave source 14 or the electronic device 16 determines if the information encoded in the carrier wave response 19 is indicative of user actuation of the first user actuatable switch 22a (e.g., selection of key or button A 38a). If the information encoded in the carrier wave response 19 is indicative of user actuation of the first user actuatable switch 22a, the carrier wave source 14 or the electronic device 16 performs an action associated with the selection of the first user actuatable switch 22a at 58. The carrier wave source 14 or the electronic device 16 may cause the action to be performed or may itself perform the action. For example, the action may include turning ON or OFF the electronic device 16 or a feature of the electronic device. Control then returns to 46. Otherwise, control passes to 60.

At 60, the carrier wave source 14 or the electronic device 16 determines if the information encoded in the carrier wave response 19 is indicative of user actuation of the second user actuatable switch 22b (e.g., selection of key or button B 38b). If the information encoded in the carrier wave response 19 is indicative of user actuation of the second user actuatable switch 22b, the carrier wave source 14 or the electronic device 16 performs an action associated with the selection of the second user actuatable switch 22b at 62. The carrier wave source 14 or the electronic device 16 may cause the action to be performed or may itself perform the action. For example, the action may include adjusting a volume or channel of the electronic device 16. Control then returns to 46. Otherwise, control passes to 64.

At 64, the carrier wave source 14 or the electronic device 16 determines if the information encoded in the carrier wave response 19 is indicative of user actuation of the third user actuatable switch 22c (e.g., selection of key or button C 38c). If the information encoded in the carrier wave response 19 is indicative of user actuation of the third user actuatable switch 22c, the carrier wave source 14 or the electronic device 16 performs an action associated with the selection of the third user actuatable switch 22c at 66. The carrier wave source 14 or the electronic device 16 may cause the action to be performed or may itself perform the action. For example, the action may include adjusting a volume or channel of the electronic device 16. Control then returns to 46. If the information encoded in the carrier wave response 19 is not indicative of user actuation of the third user actuatable switch 22c, control passes to 64 without performing the associated action 66.

The method 400 may include additional acts and/or operations. For example, the method 400 may include additional acts or operations where the remote control 12 includes more user actuatable switches 22 than those illustrated. Additionally, or alternatively, the method 400 may include additional acts such as encrypting and/or decrypting information. Further, the method 400 may omit some acts or operations, and/or perform acts or operations in a different order than set out in the Figure.

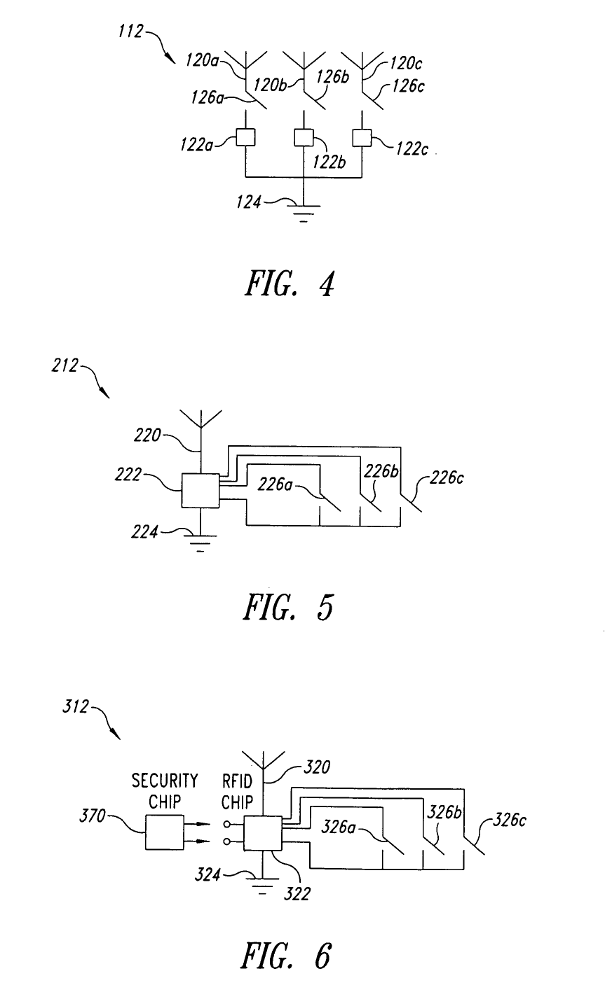

FIG. 4 shows a wireless remote control 112, according to another illustrated embodiment.

The wireless remote control 112 includes a plurality of antennas 120a, 120b, 120c (three illustrated in FIG. 4, collectively referenced as 120) electrically coupleable to respective passive power supply circuits 122a, 122b, 122c by user actuatable switches 126a, 126b, 126c, respectively. The passive power supply circuits 122 are commonly coupled to a ground 124. The antennas 120 may have identical shapes, configurations or structures. Such an approach may make the remote control 112 more modular, allowing the user of off-the-shelf RFID tags or circuits, and thereby reducing costs. Alternatively, the antennas 120 may have different shapes, configurations or structures from one another. Such may allow some antennas 120 to have higher sensitivity than others, or to have higher or more defined directionality with respect to the other antennas 120.

FIG. 5 shows a wireless remote control 212 according to another illustrated embodiment.

The wireless remote control 212 employs a single passive power supply circuit 222 coupled to a single antenna 220 and ground 224. The power supply circuit 222 receives control signals from a plurality of user actuatable switches 226a, 226b, 226c (three illustrated in FIG. 5, collectively referenced as 226). The passive power supply circuit 222 modulates the carrier wave 18 (FIG. 1) with an appropriate piece of information based on which one or combination of the user actuatable switches 226 is actuated.

FIG. 6 shows a wireless remote control 312 according to another illustrated embodiment.

The wireless remote control 312 includes an antenna 320, passive power supply circuit 322, ground 324 and user actuatable switches 326, similar or identical to the similarly named components of the embodiment shown in FIG. 5. The wireless remote control 312 further includes a security module 370 that is selectively removable with respect to the wireless remote control 312. The passive power supply circuit 322 or other elements or aspects of the wireless remote control 312 are only operable when the security module is present. Alternatively, passive power supply circuit 322 or other elements or aspects of the wireless remote control 312 provide enhanced functionality or operability only when the security module is present. The security module 370 may, for example, be physically plugged in to, or otherwise physically engage a switch or other structure of the wireless remote control 312. Alternatively, or additionally, the security module 370 may, for example, electrically or inductively couple or engage one or more terminals of the remote control 312. In such embodiments, the electrical or inductive coupling or engagement of the security module 370 may be sufficient to allow operation or to allow access to the enhanced functionality or operability. Alternatively, in such embodiments, operation or access to the enhanced functionality or operability may require the transfer of data or other information from the security module 370. For example, the security module may provide a signed response to an inquiry using a ciphering algorithm or a form of public/private key exchanges. Alternatively, or additionally, the security module 370 may, for example, optically coupled to an optical port of the wireless remote control 312. In such embodiments, the optical coupling or engagement of the security module 370 may be sufficient to allow operation or to allow access to the enhanced functionality or operability. Alternatively, in such embodiments, operation or access to the enhanced functionality or operability may require the transfer of data or other information from the security module 370.

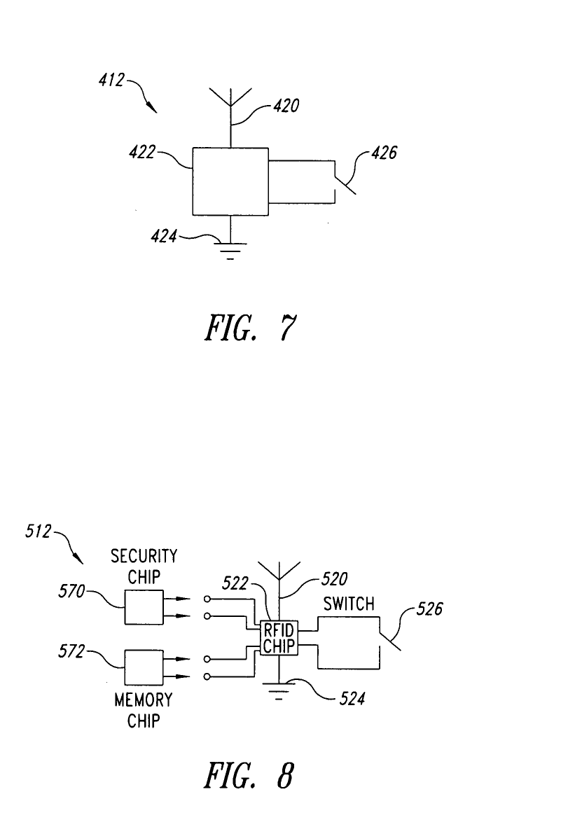

FIG. 7 shows a wireless remote control 412 according to another illustrated embodiment.

The wireless remote control 412 includes an antenna 420, passive power supply circuit 422, ground 424, and one or more switches 426 with programmable functionality. In particular, the power supply circuit 422 may include one or more internal electronic switches which may be programmed or reprogrammed to change the functionality of one or more of the user actuatable switches 426. The passive power supply circuit 422 may be programmed using electromagnetic waves, light, for example ultraviolet (UV) light, infrared (IR) light, or may be programmed using current, voltage, inductance, magnets and/or optical signals. Such embodiments may employ electronically programmable memory (EPROM), electronically erasable programmable memory (EEPROM), or flash memory techniques.

FIG. 8 shows a wireless remote control 512 according to another illustrated embodiment.

The wireless remote control 512 includes an antenna 520, passive power supply circuit 522, ground 524, and one or more user actuatable switches 526. The wireless remote control 512 may further include a security module or chip 570, similar or identical to that discussed above in reference to the embodiment of FIG. 6. The wireless remote control 512 may further include one or more memory modules or chips 572 that are selectively removable from the wireless remote control 512. The memory modules 572 may store one or more pieces of data and/or instructions. Memory module 572 may be a read-only memory module or a read-write memory module. The memory module 572 may take the form of read only memory (ROM), random access memory (RAM), EPROM, EEPROM, or flash memory, to name a few.

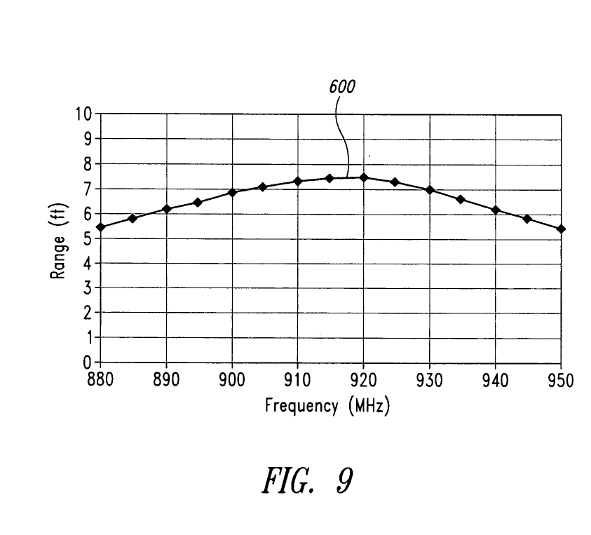

FIG. 9 shows a graph 600 of a measured read range performance of an exemplary wireless remote control, according to one illustrated embodiment.

Measurements were performed for EIRP=4 W in free space using an anechoic chamber and an ISO 18000-6B RFID reader. The wireless remote control appears to work reliably over the distance of 7 feet in the 915 megahertz UHF band. The wireless remote control can be designed to operate in a variety of UHF frequencies. The Wireless remote control may be optimized to give read range performance comparable with the performance of commercially available RFID tags, for example, up to 40 feet in free space. The wireless remote control may advantageously eliminate the need for batteries. Such can provide unlimited life without the need of replacing or recharging the power source. The elimination of batteries may also allow wireless remote controls to be reduced in size and weight, for example, down to the dimensions of a credit card and thickness of a piece of paper. Since batteries are not necessary, the wireless remote control may advantageously be permanently sealed or encapsulated, thus rendering such completely water or weatherproof. The approach taught above may be mechanically reliable and provide a cost-efficient and simple structure to build and maintain.

The passive power supply circuits and antennas of the various previously described embodiments may be identical or similar to those taught in U.S. Pat. Nos. 5,942,987 and 6,078,259, or other patents, patent publications or non-patent publications directed to the field of radio frequency identification (RFID). Typically, passive backscattered RFID systems employ a base station or reader that transmits a modulated signal with periods of un-modulated carrier, which is received the antenna of the RFID tag or circuit. An RF voltage developed on the antenna terminals during the un-modulated period is converted to a direct current (DC) which powers the RFID tag or circuit. The RFID tag or circuit transmits back information by varying a front end complex RF input impedance. The impedance typically toggles between two different states, between conjugate match and some other impedance, effectively modulating the backscattered signal. As explained herein, the wireless remote control may employ a similar or identical approach.

All of the above U.S. patents, U.S. patent application publications, U.S. patent applications, foreign patents, foreign patent applications and non-patent publications referred to in this specification and/or listed in the Application Data Sheet, including but not limited to U.S. Pat. Nos. 5,942,987 and 6,078,259, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

We/I claim:

1. A wireless remote control operable to control at least one remote device, comprising:
at least a first antenna configured to receive carrier waves from a carrier wave source that is separate and distinct from the wireless remote control;
at least a first passive power supply circuit configured to modulate at least some of the carrier waves received via the first antenna with information, and to cause the wireless remote control to backscatter the modulated carrier waves; and
at least the first user actuatable switch operable to selectively cause the first passive power supply circuit to modulate the received carrier wave with a first piece of information.

2. The wireless remote control of claim 1 wherein the carrier wave modulated with the first piece of data is backscattered via the first antenna.

3. The wireless remote control of claim 1, further comprising:
at least a second user actuatable switch operable to selectively cause the first passive power supply circuit to modulate at least some of the received carrier waves with a second piece of information, different from the first piece of information.

4. The wireless remote control of claim 1, further comprising:
a number of additional user actuatable switches in addition to the first user actuatable switch, each of the additional user actuatable switches operable to selectively cause the first passive power supply circuit to modulate at least some of the received carrier waves with respective pieces of information, different from each of the other pieces of information.

5. The wireless remote control of claim 1 wherein the first user actuatable switch is operable to selectively electrically couple the first antenna to the first passive power supply circuit and electrically uncouple at least the first antenna from the first passive power supply circuit.

6. The wireless remote control of claim 1 wherein a total number of user actuatable switches is equal to a total number of passive power supply circuits.

7. The wireless remote control of claim 1 wherein a total number of user actuatable switches is greater than a total number of passive power supply circuits.

8. The wireless remote control of claim 1, further comprising:
a security module selectively removable with respect to the wireless remote control, a presence of the security module at the wireless remote control necessary to the modulation of the carrier waves by the first passive power supply circuit.

9. The wireless remote control of claim 1, further comprising:
a memory module selectively removable from the wireless remote control, the memory module configured to store at least one of data or instructions.

10. The wireless remote control of claim 1 wherein the first passive power supply circuit is reconfigurable to change the piece of information modulated into the carrier waves in response to selection via the first user actuatable switch.

11. The wireless remote control of claim 1 wherein all of the passive power supply circuits are the sole power source of the wireless remote control.

12. A wireless, batteryless, remote control operable to control at least one remote device, comprising:
at least a first antenna configured to receive carrier waves from a carrier wave source, the carrier wave source being separate and distinct from the wireless, batteryless, remote control;
at least a first user actuatable switch; and
at least a first passive power supply circuit operatively coupleable to at least the first antenna by at least the first user actuatable switch, and configured to modulate at least some of the carrier waves received via the first antenna with a first piece of information, and to cause the wireless, batteryless, remote control to backscatter the modulated carrier waves, wherein the first user actuatable switch is operable to selectively electrically couple at least the first antenna to the first passive power supply circuit and electrically uncouple at least the first antenna from the first passive power supply circuit.

13. The wireless, batteryless, remote control of claim 12 wherein passive power supply circuit is selectively operatively coupleable by the first user actuatable switch to backscatter the modulated carrier waves via the first antenna.

14. The wireless, batteryless, remote control of claim 12, further comprising:
at least a second user actuatable switch; and
at least a second passive power supply circuit operatively coupleable to the first antenna by the second user actuatable switch, and configured to modulate at least some of the carrier waves received via the first antenna with a second piece of information, different from the first piece of information, and to cause the first antenna to backscatter the modulated carrier waves, wherein the second user actuatable switch is operable to selectively electrically couple the first antenna to the second passive power supply circuit and electrically uncouple the first antenna from the second passive power supply circuit.

15. The wireless, batteryless, remote control of claim 12, further comprising:
at least a second user actuatable switch;
at least a second passive power supply circuit operatively coupleable to the first antenna by the second user actuatable switch, and configured to modulate at least some of the carrier waves received via the first antenna with a second piece of information, different from the first piece of information, and to cause the first antenna to backscatter the modulated carrier waves, wherein the second user actuatable switch is operable to selectively electrically couple the first antenna to the second passive power supply circuit and electrically uncouple the first antenna from the second passive power supply circuit.
at least a third user actuatable switch; and
at least a third passive power supply circuit operatively coupleable to the first antenna by the third user actuatable switch, and configured to modulate at least some of the carrier waves received via the first antenna with a third piece of information, different from the first and the second pieces of information, and to cause the first antenna to backscatter the modulated carrier waves, wherein the third user actuatable switch is operable to selectively electrically couple the first antenna to the third passive power supply circuit and electrically uncouple the first antenna from the third passive power supply circuit.

16. The wireless, batteryless, remote control of claim 15 wherein the first, the second, and the third pieces of information are each respective identifiers.

17. The wireless, batteryless, remote control of claim 12, further comprising:
a second antenna configured to receive carrier waves from the carrier wave source;
at least a second user actuatable switch;
at least a second passive power supply circuit operatively coupleable to the second antenna by the second user actuatable switch, and configured to modulate at least some of the carrier waves received via the second antenna with a second piece of information, different from the first piece of information, and to cause the second antenna to backscatter the modulated carrier waves, wherein the second user actuatable switch is operable to selectively electrically couple the second antenna to the second passive power supply circuit and electrically uncouple the second antenna from the second passive power supply circuit.

18. The wireless, batteryless, remote control of claim 12, further comprising:
a second antenna configured to receive carrier waves from the carrier wave source;
a second user actuatable switch;
a second passive power supply circuit operatively coupleable to the second antenna by the second user actuatable switch, and configured to modulate at least some of the carrier waves received via the second antenna with a second piece of information, different from the first piece of information, and to cause the second antenna to backscatter the modulated carrier waves, wherein the second user actuatable switch is operable to selectively electrically couple the second antenna to the second passive power supply circuit and electrically uncouple the second antenna from the second passive power supply circuit;
at least a third antenna configured to receive carrier waves from the carrier wave source;
at least a third user actuatable switch; and
at least a third passive power supply circuit operatively coupleable to the third antenna by the third user actuatable switch, and configured to modulate at least some of the carrier waves received via the third antenna with a third piece of information, different from the first and the second pieces of information, and to cause the third antenna to backscatter the modulated carrier waves, wherein the third user actuatable switch is operable to selectively electrically couple the third antenna to the third passive power supply circuit and electrically uncouple the third antenna from the third passive power supply circuit.

19. The wireless, batteryless, remote control of claim 18 wherein the first, the second, and the third pieces of information are each respective identifiers that are unique over a group of fifty.

20. The wireless, batteryless, remote control of claim 18, further comprising:
at least a second user actuatable switch operable to selectively electrically couple the first antenna to the first passive power supply circuit and electrically uncouple the second antenna from the second passive power supply circuit.

21. A method of operating a wireless, batteryless, remote control, the method comprising:
receiving a carrier wave at a first antenna;
receiving a user selection via at least a first user actuatable switch;
modulating the carrier wave based on the received user selection; and
backscattering the modulated carrier wave from the wireless, batteryless, remote control.

22. The method of claim 21 wherein modulating the carrier wave based on the received user selection comprises modulating the carrier wave with a first piece of information in response to a user selection of the first user actuatable switch.

23. The method of claim 21 wherein modulating the carrier wave based on the received user selection comprises modulating the carrier wave with a first piece of information in response to a user selection of the first user actuatable switch, or modulating the carrier wave with a second piece of information in response to a user selection of the second user actuatable switch, the second piece of information different from the first piece of information.

24. The method of claim 21 wherein modulating the carrier wave based on the received user selection comprises modulating the carrier wave with a first piece of information in response to a first user selection of the first user actuatable switch, or modulating the carrier wave with a second piece of information in response to a second user selection of the first user actuatable switch, the second piece of information different from the first piece of information.

25. The method of claim 21, further comprising:
electrically coupling the first antenna to the first passive power supply circuit in response to the user selection received via the first user actuatable switch.

26. The method of claim 21, further comprising:
disabling the modulating the carrier wave based on the received user selection unless a security module is present at the wireless remote control.

27. The method of claim 21, further comprising:
communicating with a memory module when the memory module is present at the wireless remote control.

28. The method of claim 21, further comprising:
receiving a programming instruction; and
in response to the received programming instruction, changing the piece of information that is modulated into the carrier wave in response to selection by the first user actuatable switch.

29. A system, comprising:
a carrier wave source;
a wireless remote control comprising at least a first antenna configured to receive carrier waves from the carrier wave source, at least a first passive power supply circuit configured to modulate at least some of the carrier waves received via the first antenna with information, and to cause the wireless remote control to backscatter the modulated carrier waves; and at least the first user actuatable switch operable to selectively cause the first passive power supply circuit to modulate the received carrier wave with a first piece of information; and
at least one electronic device remotely operable via the remote control, at least one electronic device comprising a second antenna configured to receive the modulated carrier waves from the wireless remote control, the remote device responsive to the information modulated in the modulated carrier wavers backscattered by the remote control.

30. The system of claim 29 wherein the carrier wave modulated with the first piece of data is backscattered via the first antenna.

31. The system of claim 29 wherein the wireless remote control further comprises:
at least a second user actuatable switch operable to selectively cause the first passive power supply circuit to modulate at least some of the received carrier waves with a second piece of information, different from the first piece of information.

32. The system of claim 29 wherein the carrier wave source is formed as part of the electronic device.

33. A method of operating a wireless remote controlled system, the method comprising:
transmitting a carrier wave;
receiving a carrier wave response indicative of a user selection made via a wireless remote control;
determining information encoded in the received carrier wave response that is indicative of the user selection;
controlling an electronic device based on the determined information.

34. The method of claim 33 wherein receiving a carrier wave response indicative of a user selection made via a wireless remote control comprises receiving a backscattered modulated carrier wave from the wireless remote control.

35. The method of claim 33 wherein controlling an electronic device based on the determined information comprises providing control signals from a carrier wave source to the electronic device to cause the electronic device to perform an action indicated by the determined information.
